(19) United States
(12) Patent Application Publication
(10) Pub. No.: US 2026/0281945 A1
(43) Pub. Date: Sep. 17, 2026

(54) SELECTION OF A PRU BASED ON CHANNEL CONDITIONS

(71) Applicant: InterDigital Patent Holdings, Inc., Wilmington, DE (US)

(72) Inventors: Tao Deng, New York, NY (US); Fumihiro Hasegawa, Westmount (CA); Tuong Duc Hoang, Montreal (CA); Paul Marinier, Brossard (CA); Moon-il Lee, Melville, NY (US)

(73) Assignee: InterDigital Patent Holdings, Inc., Wilmington, DE (US)

(21) Appl. No.: 19/168,499

(22) PCT Filed: Apr. 3, 2024
(86) PCT No.: PCT/US2024/022737

§ 371 Date: Sep. 24, 2025

Related U.S. Application Data
(60) Provisional application No. 63/456,891, filed on Apr. 4, 2023.

(51) Int. Cl. H04W 64/00; H04B 7/06; H04L 5/00; H04W 24/08; H04W 92/18

(52) U.S. Cl. CPC H04W 64/00; H04B 7/06968; H04L 5/0051; H04W 24/08; H04W 92/18

(57) ABSTRACT

A wireless transmit/receive unit (WTRU) configured to: send, to a first positioning reference unit (PRU) and a second PRU, a channel condition measurement request indicating a request for the first PRU to perform first channel condition measurements associated with a first link between the first PRU and an anchor WTRU, and for the second PRU to perform second channel condition measurements associated with a second link between the second PRU and the anchor WTRU; receive the first channel condition measurements from the first PRU and the second channel condition measurements from the second PRU; perform third channel condition measurements associated with a link between the WTRU and the anchor WTRU; select a PRU based on the first, second, and third channel condition measurements; and send a third request to the selected candidate PRU indicating for the selected candidate PRU to join a sidelink positioning group.

### CROSS-REFERENCE TO RELATED APPLICATIONS

This application claims the benefit of U.S. Provisional Application No. 63/456,891, filed Apr. 4, 2023 the contents of which is incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, devices, and instrumentalities are described herein related to selection of a PRU based on channel conditions.

A device (e.g., a target wireless transmit/receive unit (WTRU) may be configured to send, to each of a first candidate positioning reference unit (PRU) and a second candidate PRU, a channel condition measurement request. The channel condition measurement request may indicate a first request for the first candidate PRU to perform a first channel condition measurement associated with a first link between the first candidate PRU and an anchor WTRU, and a second request for the second candidate PRU to perform a second channel condition measurement associated with a second link between the second candidate PRU and the anchor WTRU. The device may receive the first channel condition measurement from the first candidate PRU and the second channel condition measurement from the second candidate PRU. The device may perform a third channel condition measurement associated with a link between the device and the anchor WTRU. The device may select a candidate PRU, from at least the first candidate PRU and the second candidate PRU, based on the first channel condition measurement, the second channel condition measurement, and the third channel condition measurement. The device may send a third request to the selected candidate PRU. The third request indicates for the selected candidate PRU to join a sidelink positioning group.

The device may compare the first channel condition measurement with the third channel condition measurement to determine a first channel condition difference. The device may compare the second channel condition measurement with the third channel condition measurement to determine a second channel condition difference. On a condition that the first channel condition difference is smaller than the second channel condition difference, the device may select the first candidate PRU. On a condition that the second channel condition difference is smaller than the first channel condition difference, the device may select the second candidate PRU.

The device may determine that a distance between the first anchor WTRU and a second anchor WTRU is below a threshold. Based on the determination that the distance between the first anchor WTRU and the second anchor WTRU is below the threshold, the device may select sidelink reference signal resources that are multiplexed at a sub-carrier level. The third channel condition measurement may be performed based on the selected sidelink reference signal resources. The device may perform a fourth channel condition measurement associated with a link between the device and the second anchor WTRU. The fourth channel condition measurement may be performed based on the selected sidelink reference signal resources. The device may select the PRU further based on the fourth channel condition measurement.

The device may send the first request is sent to a third candidate PRU. The first request may indicate for the third candidate PRU to perform a fourth channel condition measurement associated with a link between the third candidate PRU and the anchor WTRU. The device may receive an indication of the fourth channel condition measurement from the third candidate PRU. The device may select the PRU further based on the fifth channel condition measurement.

The first request may indicate a time window in which to perform the first channel condition measurement, the second channel condition measurement, and the third channel condition measurement. The first request may be sent via a broadcast transmission. The device and the selected PRU may have a quasi-colocation relationship.

The first channel condition measurement, the second channel condition measurement, and/or the third channel condition measurement may include one or more of: a reference signal received power (RSRP) value; a signal-to-noise ratio; a line-of-sight indication; a channel quality indicator; a delay spread; a Doppler shift; a Doppler spread; an average delay; a number of detected multi-paths; or an RSRP per path value.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of target WTRU transmission of a sidelink muting indicating based on interference detection.

FIG. 3 illustrates an example of an anchor WTRU determining a set of sidelink positioning reference signal (SL-PRS) transmissions to use for a target WTRU-based SL positioning calculation.

FIG. 4 illustrates an example of an anchor WTRU determining a target WTRU's SL-PRS transmission configuration.

FIG. 5 illustrates an example round trip time (RTT)-based sidelink positioning with PRU assistance information.

### DETAILED DESCRIPTION

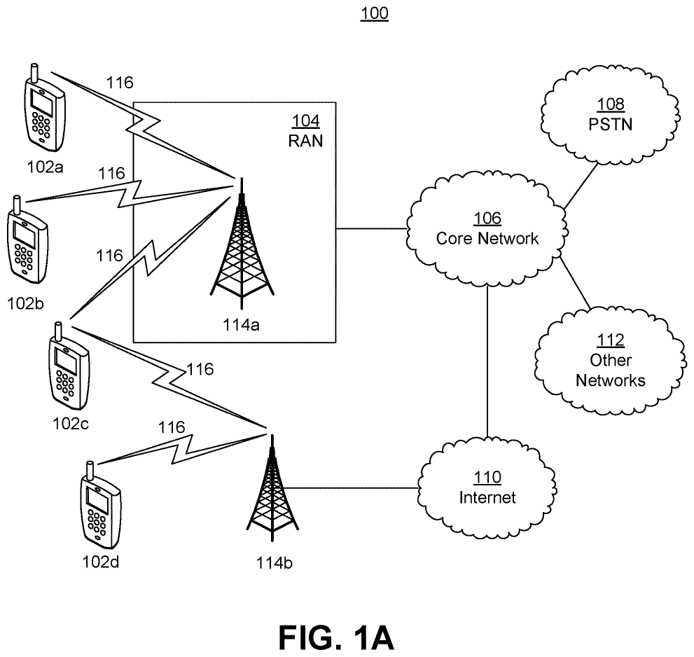

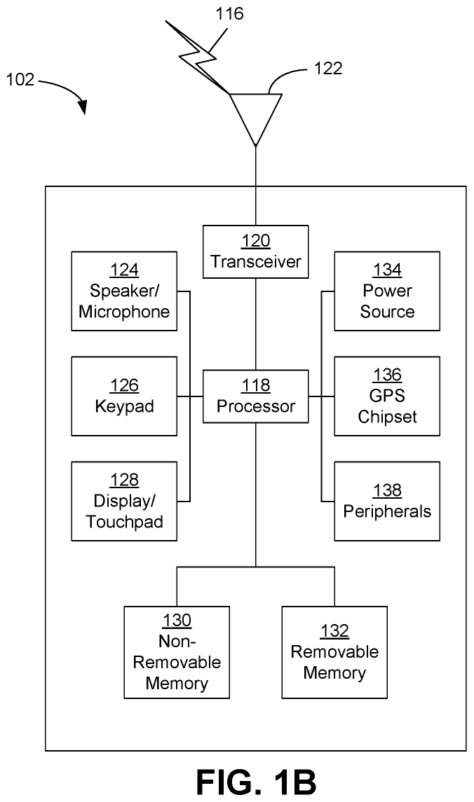

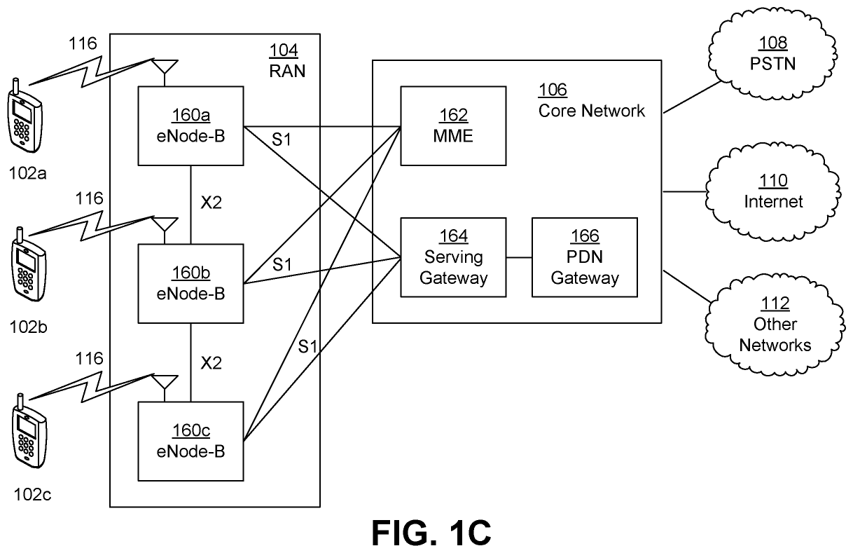

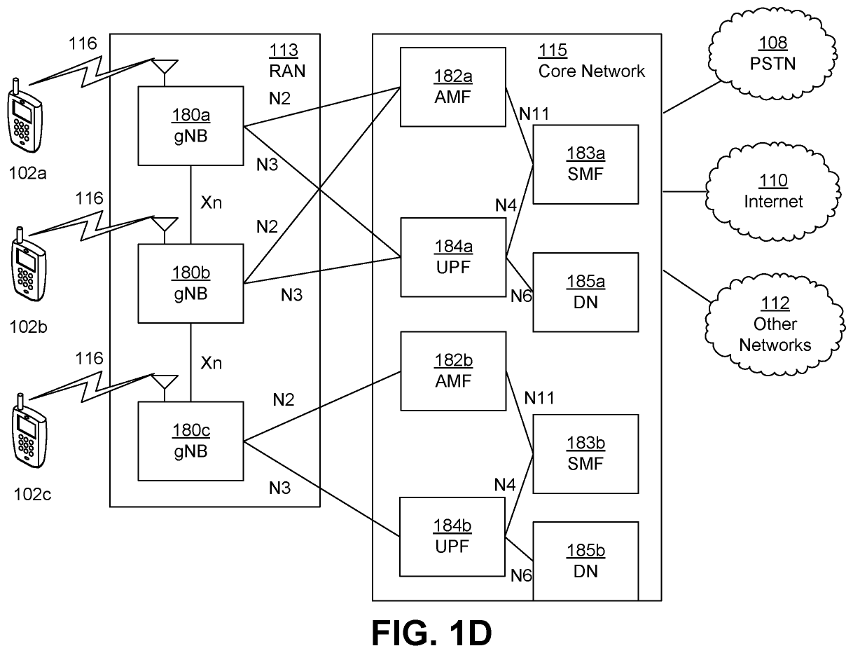

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Feature(s) associated with sidelink (SL) positioning are provided herein.

SL positioning may include SL-only-base positioning and a combination of SL-based positioning and Uu-based positioning. SL positioning may involve determining SL-RTT (Round Trip Time), SL-AoA (Angle of Arrival) and SL-TDoA (Time Difference of Arrival). For SL-TDoA, both DL-TDoA and UL-TDoA may be used.

Timing/angling positioning or a timing/angle positioning method may refer to any positioning technique that uses reference signals (e.g., SL positioning reference signals (SL-PRSs)). The WTRU may receive one or more (e.g., multiple) reference signals from other WTRU(s). The WTRU may measure reference signal time difference (RSTD), reference signal received power (RSRP), and/or AoA. Examples of angle/timing positioning include SL-AoD or SL-TDOA positioning. The WTRU may transmit SL-PRS to other WTRU(s). The other WTRU(s) may perform measurements (e.g., RSTD, AoA, RSRP). The other WTRU may determine the location of the WTRU that transmitted the SL-PRS (e.g., based on the measurements).

RTT positioning or a RTT positioning method may refer to any positioning technique that involves two WTRUs transmitting SL-PRS to each other. For example, an anchor WTRU may transmit SL-PRS to a target WTRU. If the target WTRU receives SL-PRS from the anchor WTRU, the target WTRU may transmit SL-PRS to the anchor WTRU. The target WTRU may measure the WTRU Tx-Rx time difference (e.g., the difference between transmission time of the SL-PRS from the target WTRU and reception time of the SL-PRS transmitted from the anchor WTRU). The target WTRU may report the WTRU Tx-Rx time difference to the anchor WTRU and/or network (e.g., gNB, LMF).

As used herein, the term network may refer to an AMF, location management function (LMF), gNB, or NG-RAN. The terms pre-configuration and configuration may be used interchangeably herein. The terms non-serving gNB and neighboring gNB may be used interchangeably herein. The terms gNB and TRP may be used interchangeably herein. The terms PRS or PRS resource may be used interchangeably herein. The terms PRS(s) or PRS resource(s) may be used interchangeably herein. The PRS(s) or PRS resource(s) may belong to different PRS resource sets. The terms PRS or DL-PRS or DL PRS may be used interchangeably herein. The terms measurement gap or measurement gap pattern may be used interchangeably herein. A measurement gap pattern may include parameters such as a measurement gap duration, a measurement gap repetition period, and/or a measurement gap periodicity.

A target WTRU may be a WTRU whose location information is to be acquired based on SL positioning measurements (e.g., in accordance with configured SL positioning techniques(s). The SL positioning measurements may be performed by the target WTRU and/or anchor WTRU(s). Anchor WTRU(s) may be WTRU(s) discovered and/or identified by the network (e.g., LMF and/or gNB) and/or a target WTRU. An LMF may be a non-limiting example of a node or entity (e.g., network node or entity) that may be used for or to support positioning. Any other node or entity may be substituted for LMF and still be consistent with this disclosure.

A server WTRU may be a WTRU and/or TRP that is capable of performing LMF functionalities (e.g., including positioning result calculation, positioning technique determination, assistant data distribution, and/or SL anchor WTRU selection).

SL-PRS is an example SL reference signal that may be used in SL positioning techniques. An SL-PRS transmission may use a comb pattern and a pseudorandom-based sequence. The SL-PRS transmission may be based on two resource allocation schemes. In a first example scheme, SL-PRS resource allocation may be performed by the network. In a second example scheme, a WTRU may perform autonomous SL-PRS resource allocation based on SL sensing (e.g., legacy SL Mode 2 resource selection).

In one example, an SL-PRS configuration may contain at least one of the following parameters: number of symbols, transmission power, number of SL-PRS resources included in SL-PRS resource set, muting pattern for SL-PRS (e.g., the muting pattern may be expressed via a bitmap), periodicity, type of SL-PRS (e.g., periodic, semi-persistent, or aperiodic), slot offset for periodic transmission for SL-PRS, vertical shift of SL-PRS pattern in the frequency domain, time gap during repetition, repetition factor, RE (resource element) offset, comb pattern, comb size, spatial relation, QCL information (e.g., QCL target, QCL source) for SL-PRS, number of PRUs, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for PRS transmission, on/off indicator for SL-PRS, TRP ID, SL-PRS ID, cell ID, global cell ID, PRU ID, and/or applicable time window. The WTRU may apply an SL-PRS configuration under a condition that the current time is within the applicable time window.

Feature(s) associated with a positioning reference unit (PRU) are provided herein.

A PRU may be a WTRU or TRP whose location (e.g., altitude, latitude, geographic coordinate, or local coordinate) is known. Capabilities of a PRU may be the same as a WTRU or TRP (e.g., capable of receiving PRS, transmitting SRS, transmitting SRS for positioning, transmitting return measurements, or transmitting PRS). The PRU measurements may be compared with the measurements expected at the known PRU location for the purpose of correction of the Uu DL or UL location measurements performed for a target WTRU. I In Uu positioning, simultaneous measurements of the same DL-PRS at the target WTRU and PRU and simultaneous transmissions of SRS from the PRU and target WTRU may occur.

To apply a positioning measurement result based on PRU transmission/reception to the positioning of a target WTRU, the positioning measurements used for the PRU and target WTRU positioning determination may be highly comparable. Such a comparability may be determined by evaluating the channel condition of two radio links (e.g., the sidelink between the target WTRU and the anchor WTRU and the sidelink between the PRU and the anchor WTRU). The SL-PRS transmission and/or measurement configuration used by the target WTRU may be aligned with an associated PRU.

For example, if an SL positioning is based on a measurement by a target WTRU and its associated PRU on an SL-PRS transmission from an anchor WTRU, the SL-PRS transmission measured at the PRU may experience similar (e.g., very similar) channel conditions as the SL-PRS transmission measured at the target WTRU. Similarly, if an SL position is based on a measurement by one or more anchor WTRU(s) on SL-PRS transmission by a target WTRU and its associated PRU, the SL-PRS transmissions from the target WTRU and its associated PRU may experience correlated (e.g., highly correlated) channel condition when arriving at the anchor WTRU(s).

In Uu positioning, for a target WTRU, a gNB may select one or more PRUs whose DL and UL channel conditions are similar (e.g., very similar) to the target WTRU's channel conditions. The gNB may make this selection based on either (e.g., standardized) DL/UL measurements or other (e.g., proprietary) mechanisms. As a result, the gNB/network may perform an selection of a PRU associated with a target WTRU. The gNB/network may coordinate and/or indicate similar configuration of SRR transmissions for positioning (e.g., TX beam to use) and measurements of DL-PRS transmissions by a target WTRU and PRU.

However, the gNB and network may not be involved in SL operation (e.g., the second example scheme described herein) or the gNB may not know the channel condition of the sidelink between target WTRU and anchor WTRU and the sidelink between the PRU and anchor WTRU. Feature(s) associated with WTRU-based PRU selection and transmission/reception configuration coordination between PRU and target WTRU are described herein for PRU-assisted SL positioning.

To achieve high SL positioning accuracy, the SL positioning measurements (on SL-PRS transmission by an anchor WTRU) may be performed simultaneously by a target WTRU and its associated PRU (e.g., similar to Uu positioning with PRU). For SL positioning measurements performed by anchor WTRU(s) on SL-PRS transmissions from a target WTRU and PRU, simultaneous transmissions from the target WTRU and PRU may be performed. A WTRU-based mechanism to enable simultaneous or closely-placed SL-PRS transmissions/measurements by a target WTRU and its associated PRU may be used.

A target WTRU may select an associated PRU based on the measured quasi co-located (QCLed) channel condition of an anchor WTRU-target WTRU SL and an anchor WTRU-PRU SL.

Feature(s) associated with a QCL relationship between SL-positioning measurements are provided herein.

A WTRU may perform SL positioning measurements on a received signal (e.g., an SL-PRS). The WTRU may determine that two or more SL positioning measurements are QCLed if the measured signal of each SL-positioning measurement experiences similar (e.g., very similar) and/or correlated channel conditions.

A channel condition may be characterized by a set of radio link parameters. The radio link parameters may include one or more of: number of paths, shadowing, blockage, path loss, delay spread, average delay, Doppler shift, Doppler spread, and/or CIR (Channel Impulse Response).

Examples of different types of QCL relationship are provided herein. A QCL relationship (e.g., each type of QCL relationship) may be associated with a characteristic of the channel experienced by WTRU(s). For example, WTRUs (e.g., two WTRUs) may be in a spatial QCL relationship if the WTRUS experience similar channel conditions (e.g., fading, multipath, LOS, NLOS) with respect to a reference point (e.g., Tx WTRU, gNB, TRP, PRU, RSU). In an example, WTRUs (e.g., two WTRUs) may be in a Doppler QCL relationship if the WTRUs experience similar channel conditions (e.g., Doppler spread/shift, fading) with respect to a reference point. In an example, WTRUs (e.g., two WTRUs) may be in a delay spread QCL relationship if the WTRUs experience similar channel conditions (e.g., similar delay spread in channels).

The WTRU may be configured with threshold(s) (e.g., a threshold may be expressed in terms of RSRP, Doppler frequency, Doppler spread, number of paths, LOS indicator). The WTRU may use the threshold(s) to determine whether the WTRU is in QCL relationship with another WTRU. A threshold (e.g., each threshold) may correspond to a different type of QCL relationship.

The WTRU (e.g., anchor/server WTRU) may be configured with threshold(s) to determine whether other WTRUs (e.g., two other WTRUs, for example, a target WTRU and PRU) are in a QCL relationship.

The WTRU may report the determined QCL relationship between the WTRUs (e.g., target WTRU and PRU, or the WTRU and another WTRU) to the network (e.g., LMF, gNB), target WTRU, anchor WTRU, and/or server WTRU. The WTRU may report a type of the QCL relationship (e.g., spatial QCL, Doppler QCL, etc.) to the network (e.g., LMF, gNB), target WTRU, anchor WTRU, and/or server WTRU.

Feature(s) associated with a PRU-based SL positioning measurement and target WTRU-based SL positioning measurement are provided herein.

For SL positioning measurement with PRU assistance, an SL positioning measurement may be performed as described herein.

A target WTRU-based SL positioning measurement may be performed. An anchor WTRU may perform a target WTRU-based SL positioning measurement on an SL-PRS transmitted by a target WTRU. A target WTRU may perform a target WTRU-based SL positioning measurement on an SL-PRS transmitted by an anchor WTRU.

A PRU-based SL positioning measurement may be performed. An anchor WTRU may perform a PRU-based SL positioning measurement on an SL-PRS transmitted by a PRU associated with the target WTRU. A PRU may perform a PRU-based SL positioning measurement on the SL-PRS transmitted by an anchor WTRU. The anchor WTRU may be the same anchor WTRU transmitting SL-PRS for the target WTRU-based SL positioning measurement.

A channel condition may be specific to a radio link (e.g., an SL radio link between two WTRUs). The target WTRU-based SL positioning measurement may experience the channel condition specific to the SL between the target WTRU and the anchor WTRU (e.g., sometimes referred to herein as the anchor WTRU-target WTRU SL). The PRU-based SL positioning measurement may experience the channel condition specific to the SL between PRU and anchor WTRU (sometimes referred to herein as the anchor WTRU-PRU SL).

A WTRU may determine that a target WTRU-based SL positioning measurement and a PRU-based SL positioning measurement that are QCLed if the channel condition of anchor WTRU-target WTRU SL and anchor WTRU-PRU SL are similar (e.g., very similar) and/or correlated.

Feature(s) associated with application of PRU-based SL positioning measurement information to target WTRU-based SL positioning measurement are provided herein.

A PRU may indicate its known location information (e.g., based on GNSS) to the network and/or a peer WTRU within an SL positioning group (e.g., an anchor WTRU). An anchor WTRU may have location information (e.g., its own location information, for example, based on GNSS or RAT-based positioning). An anchor WTRU may determine an SL position measurement error factor based on one or more of the following measurement results: an expected PRU-based SL positioning measurement result (e.g., angular and round trip time result based on the known location of both PRU and anchor WTRU); and/or an actual PRU-based SL positioning measurement result based on SL-PRS transmission.

An anchor WTRU may compare the two measurement results and determine one or more error factor(s). The error factor(s) may include one or more of: an angular offset, a timing offset, and/or a coordinate offset between coordinates of the known location and the calculated location. For example, the coordinate offset may include a latitude offset and a longitude offset.

For an AoA-based SL positioning measurement, a WTRU may determine an angular offset based on the difference between the measured AoA and the AoA calculated based on the location information (e.g., coordinates) of the PRU and anchor WTRU. In a RTT-based SL positioning measurement, a WTRU may determine a timing offset based on the difference between the measured round trip time and the round trip time calculated based on the distance between the known locations of PRU and anchor WTRU. An offset between the known location coordinate and the calculated location coordinate may include the difference in latitude and longitude between the calculated PRU location and the known location.

A WTRU may determine one or more error factor(s) derived from the PRU-based SL positioning measurement. The error factor(s) may be applied to correct a target WTRU-based SL positioning measurement result when the target WTRU-based SL positioning measurement and PRU-based SL positioning measurement are QCLed. In this case, similar measurement error factor(s) caused by the channel impairment to the PRU-based SL positioning measurement may occur in the target WTRU-based SL positioning measurement.

A WTRU may determine that two or more peer WTRUs in an SL positioning group are in a QCL relationship based on measurements reported by peer WTRUs. For example, the target WTRU and the selected candidate PRU may have a QCL relationship. The WTRU may indicate (e.g., via unicast, groupcast, or broadcast) the determined WTRU QCL relationship to one or more peer WTRUs. A WTRU may include the QCL relationship indication in a message (e.g., SCI, SL-MAC-CE, RRC, LPP, SLPP) to the peer WTRUs. For example, a WTRU may indicate a spatial QCL relationship between two peer WTRUs.

In one example, The WTRU may use groupcast to the WTRUs that are in the QCL relationship with each other or among themselves. The WTRU may use broadcast to inform WTRUs a pair of WTRUS or group of WTRUs who are in the QCL relationship. The WTRU may use a WTRU ID, a PRU ID, or a RSU ID to indicate the identity of an WTRU.

Using applicable error factor(s), a WTRU may adjust a target WTRU-based AoA measurement by an angular offset derived from a PRU-based round trip time measurement. A WTRU may apply a timing offset (e.g., derived from a PRU-based round trip time measurement) to a target WTRU-based round trip time measurement. A WTRU may determine a target WTRU's location information by adjusting a target WTRU-based SL positioning measurement result with the latitude and longitude offset derived from a PRU-based SL positioning measurement.

Feature(s) associated with PRU selection based on a target WTRU determination of channel correlation between an anchor WTRU-target WTRU SL and an anchor WTRU-PRU SL are provided herein.

A target WTRU may receive a configuration. The configuration may include a group of candidate PRUs. The target WTRU may receive the configuration from an LMF/gNB and/or a peer WTRU (e.g., an anchor WTRU) in an SL positioning group. To enable a PRU-based SL measurement in an SL positioning session, a target WTRU may determine a candidate PRU for PRU-based SL positioning measurement in subsequent SL positioning measurement(s) based on channel condition measurement(s) of anchor WTRU-PRU SL(s) and an anchor WTRU-target WTRU SL.

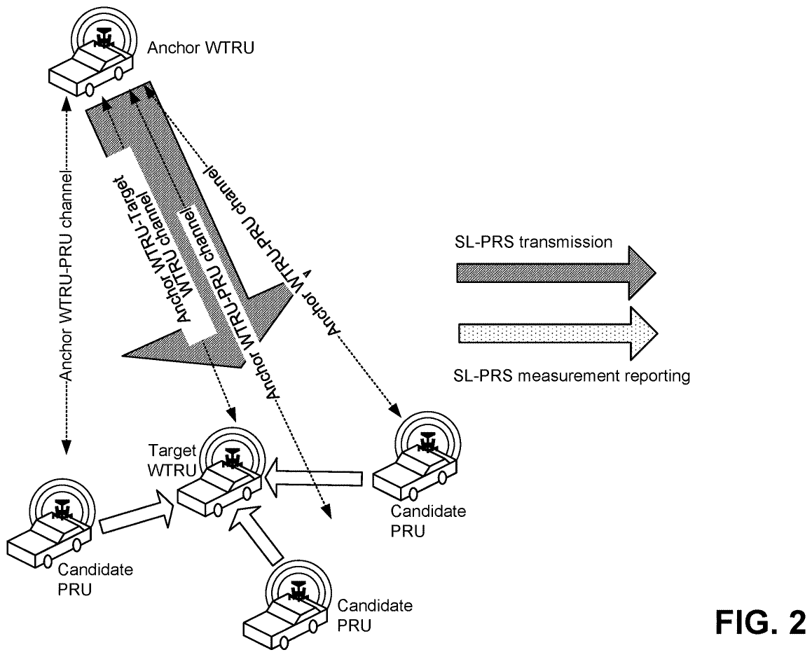

FIG. 2 illustrates a target WTRU transmission of SL muting indication based on interference detection.

A WTRU may perform a channel condition measurement of an SL radio link on an SL RS (e.g., an SL-PRS and/or SL CSI-RS transmission). For example, a candidate PRU may perform a channel condition measurement of an anchor WTRU-PRU SL based on SL RS transmission(s) from an anchor WTRU. A target WTRU may perform a channel condition measurement of an anchor WTRU-target WTRU SL based on SL RS transmission(s) from the anchor WTRU (e.g., the same anchor WTRU).

A channel condition measurement may be (pre)configured and include one or more of the following channel condition parameters: SL-PRS RSRP; SL-PRS SINR; SL-PRS CQI; Number of detected multi-paths; SL-PRS RSRPP (RSRP per Path); LOS/NLOS indicator; Doppler shift; Doppler spread; average delay; and/or delay spread.

A WTRU may send a channel condition measurement request message. The WTRU may indicate the measurement parameters in the channel condition measurement request message.

A WTRU may perform an estimate of a channel impulse response based on a received SL-PRS transmission. The channel impulse response may include a number of detected multi-paths. For each multi-path, a WTRU may measure the signal strength (e.g., RSRPP). A WTRU may determine a delay spread and an average delay based on the distribution of multi-paths in time domain. A WTRU may determine a Doppler shift and a Doppler spread based on the phase measurement of each multi-path.

A WTRU may perform an estimate of likelihood of Line-of-Sight (LOS) condition. A WTRU may determine a LOS is detected based on the number of detected multi-path and the RSRPP difference between the 1st detected multi-path and other multi-path(s). A binary scale may be (pre)configured. A WTRU may determine a zero (0) value for the NLOS condition and a one (1) value for the LOS condition. A scale between 0 to 1 with a step size of 0.1 may be (pre)configured. A WTRU may determine a zero (0) value for NLOS condition, a one (1) value for LOS condition, and an interim value to indicate a probability of LOS condition based on the measured channel condition.

A target WTRU may send a channel condition measurement request (e.g., in an SL groupcast or broadcast) transmission to anchor WTRU(s) and candidate PRUs. For example, the channel condition measurement request may indicate for a first candidate PRU to perform a first channel condition measurement associated with a link between the first candidate PRU and an anchor WTRU, and for the second candidate PRU to perform a second channel condition measurement associated with a link between the second candidate PRU and the anchor WTRU. The channel condition measurement request may indicate for a third (e.g., and fourth, fifth, etc.) candidate PRU to perform a channel condition measurement. The request transmission may include one or more of the following: resources selected for SL RS transmission(s) for anchor WTRU(s); an indication of requested channel condition measurement parameter(s); resource(s) selected for the measurement reporting transmission by candidate PRUs, and/or the like.

A target WTRU may perform a resource selection for the SL RS transmissions for one or more anchor WTRU(s). A target WTRU may select a (pre)configured SL-PRS and/or a CSI-RS for channel condition measurement. The (pre)configuration may include bandwidth, slot/symbol allocation, comb pattern (SL-PRS), resource density (CSI-RS), etc.

If a target WTRU selects SL RS resources for multiple anchor WTRUs(s), the target WTRU may be (pre)configured with a time window to include all SL RS resources. For example, the target WTRU may send an indication (e.g., in the channel condition measurement request) of the time window in which to perform channel condition measurements. The length of the time window may be a number of symbols and/or slots. The associated SL RS transmissions (e.g., transmitted on the SL RS resources) may occur in the (pre)configured time window. The channel condition of multiple anchor WTRU-PRU SLs and anchor WTRU-target WTRU SLs may be measured within a short time interval (e.g., and may be comparable). Because a radio channel may vary over time (e.g., due to blockage), two channels may be measured at about the same time.

A target WTRU may select SL RS resources multiplexed at the sub-carrier level (e.g., if the distance between the anchor WTRUs is within a (pre)configured threshold). For example, the target WTRU may determine that a distance between a first and second anchor WTRU is below a threshold. Based on the determination that the distance between the first anchor WTRU and the second anchor WTRU is below the threshold, the target WTRU may select sidelink reference signal resources that are multiplexed at a sub-carrier level. The third channel condition measurement (e.g., associated with a link between the target WTRU and the (first) anchor WTRU) is performed based on the selected sidelink reference signal resources. The target WTRU may perform a fourth channel condition measurement (e.g., associated with a link between the target WTRU and the second anchor WTRU). The fourth channel condition measurement may be performed based on the selected sidelink reference signal resources. The target WTRU may select resources for SL-PRS transmissions for different anchor WTRUs using a bandwidth and comb pattern (e.g., the same bandwidth and the same comb pattern) in one slot. Each SL-PRS transmission may use a different RE offset.

SL RS transmissions from different WTRUs and multiplexed at the sub-carrier level may experience inter-sub-carrier-interference at a receiving WTRU (e.g., if the received power levels of the SL RSs are very different). SL RS transmissions by anchor WTRUs in proximity may enable sub-carrier level multiplexing.

A target WTRU may perform a channel condition measurement (e.g., identical to the measurement indicated in the request) associated with a link between the target WTRU and the anchor WTRU) e.g., an anchor WTRU-target WTRU link). A target WTRU may receive an indication of (e.g., a PSSCH/PSCCH transmission carrying) the requested channel condition measurement reporting from each candidate PRU (e.g., in the resource indicated in the measurement request). The measurement reporting may include the requested channel condition measurement parameters (e.g., RSRP, LOS/NLOS indication, etc.) of the anchor WTRU-PRU SL measured by each candidate PRU. A target WTRU may perform a RSRP measurement of demodulation reference signals (e.g., the PSCCH-DMRS and/or PSSCH-DMRS) of the received measurement reporting transmission.

A target WTRU may select/determine a candidate PRU (e.g., from the multiple candidate PRUs) with which to associate for SL positioning based on one or more of the following measurement results: the channel condition measurement parameters of the anchor WTRU-target WTRU SL (e.g., measured by the target WTRU); the channel condition measurement parameters of the anchor WTRU-PRU SL (e.g., reported by each candidate PRU); and/or the RSRP measurement of the measurement report transmission (e.g., from each candidate PRU).

The target WTRU may select the candidate PRU by comparing the first channel condition measurement (e.g., associated with the link between the first candidate PRU and the anchor WTRU) with the third channel condition measurement (e.g., associated with a link between the target WTRU and the anchor WTRU) to determine a first channel condition difference. The target WTRU may compare the second channel condition measurement (e.g., associated with the link between the first candidate PRU and the anchor WTRU) with the third channel condition measurement to determine a second channel condition difference. On a condition that the first channel condition difference is smaller than the second channel condition difference, the target WTRU may select the first candidate PRU as the PRU. On a condition that the second channel condition difference is smaller than the first channel condition difference, the target WTRU may select the second candidate PRU as the PRU.

For example, the determination of the candidate PRU may be based on one or more of the following: the delta between the RSRP value measured on the anchor WTRU-target WTRU SL and the RSRP value reported by the PRU for the anchor WTRU-PRU SL (e.g., the PRU with the smallest delta among the reported RSRP values may be selected); the delta between the LOS/NLOS indication measured on the anchor WTRU-target WTRU SL and the LOS/NLOS indication reported by the PRU for the anchor WTRU-PRU SL (e.g., the PRU with the smallest delta among the reported RSRP values may be selected); the delta between the CQI value measured on the anchor WTRU-target WTRU SL and the CQI value reported by the PRU for the anchor WTRU-PRU SL (e.g., the PRU with the smallest delta among the reported RSRP values may be selected); the delta between the delay spread measured on the anchor WTRU-target WTRU SL and the delay spread reported by the PRU for the anchor WTRU-PRU SL (e.g., the PRU with the smallest delta among the reported RSRP values may be selected); the delta between the number of paths and average RSRPP measured on anchor WTRU-target WTRU SL and the number of paths and average RSRPP reported by the PRU for the anchor WTRU-PRU SL (e.g., the PRU with the smallest delta among the reported RSRP values may be selected).

The determined PRU may have the anchor WTRU-PRU SL with the channel condition that is the most correlated with the channel condition measured on the anchor WTRU-target SL. The target WTRU may determine to apply the PRU-based SL positioning measurement (e.g., performed by the determined PRU) to the target WTRU-based SL positioning measurement to improve the SL positioning accuracy.

If multiple candidate PRUs report similar channel condition parameter(s), a target WTRU may determine (e.g., select) a PRU with the smallest RSRP (e.g., measured on the PRU's measurement reporting transmission).

A WTRU (e.g., a target WTRU) may receive a configuration of a group of candidate PRUs and anchor WTRUS.

The WTRU may select a set of resources for each anchor WTRU's SL-PRS transmission and each PRU's measurement reporting transmission. The SL-PRS resources may be within a slot or consecutive slots.

The SL-PRS resources may be frequency domain multiplexed (FDMed) if the distances between each anchor WTRU and target WTRU are within a (pre)configured threshold.

The WTRU may send a channel condition measurement request in a groupcast transmission. The channel condition measurement request may include the selected resources for SL-PRS transmission by the anchor WTRUs; and/or a request for channel condition measurements (e.g., LOS/NLOS, RSRP, delay spread, CIR parameters, etc.) by the PRUS.

The WTRU may perform channel condition measurements on the SL-PRS transmissions (e.g., in the selected resources) from the anchor WTRUs.

The WTRU may receive transmissions (e.g., PSSCH/PSCCH transmissions) carrying the measurement reporting from each candidate PRU. The WTRU may perform RSRP measurements on DMRS of the transmissions.

The WTRU may determine a PRU based on the SL-PRS channel condition measurement result reported by each candidate PRU and measured by the target WTRU. For example, the WTRU may select the PRU associated with the smallest delta LOS/NLOS value, delta RSRP, smallest delta delay spread, etc.).

The WTRU may determine a PRU based on the channel condition measured on the measurement reporting transmission from each PRU (e.g., RSRP smaller than a threshold).

The WTRU may send a request to the selected/determined PRU that indicates for the selected PRU to join an SL positioning group/session.

A target WTRU may send, to each of a first candidate positioning reference unit (PRU) and a second candidate PRU, a channel condition measurement request. The channel condition measurement request may indicate a first request for the first candidate PRU to perform first channel condition measurements associated with a first link between the first candidate PRU and an anchor WTRU, and a second request for the second candidate PRU to perform second channel condition measurements associated with a second link between the second candidate PRU and the anchor WTRU. The target WTRU may receive the first channel condition measurements from the first candidate PRU and the second channel condition measurements from the second candidate PRU. The target WTRU may perform third channel condition measurements associated with a link between the target WTRU and the anchor WTRU. The target WTRU may select a candidate PRU based on the first channel condition measurements, the second channel condition measurements, and the third channel condition measurements. The target WTRU may send a third request to the selected candidate PRU. The third request may indicate for the selected candidate PRU to join a sidelink positioning group.

The target WTRU may compare the first channel condition measurements with the third channel condition measurements to determine a first channel condition difference. The target WTRU may compare the second channel condition measurements with the third channel condition measurements to determine a second channel condition difference. On a condition that the first channel condition difference is smaller than the second channel condition difference, the target WTRU may select the first candidate PRU. On a condition that the second channel condition difference is smaller than the first channel condition difference, the target WTRU may select the second candidate PRU.

The first channel condition measurements, the second channel condition measurements, and/or the third channel condition measurements may include one or more of: a reference signal received power (RSRP) value; a signal-to-noise ratio; a line-of-sight indication; a channel quality indicator; a delay spread; a Doppler shift; a Doppler spread; an average delay; a number of detected multi-paths; or an RSRP per path value.

An anchor WTRU may determine a target WTRU-based SL positioning measurement for positioning calculation based on a set of PRU-based SL-PRS measurements.

Feature(s) associated with transmission configuration for an SL-PRS transmission are provided herein.

A WTRU may perform an SL-PRS transmission for SL positioning (e.g., using a transmission configuration that may impact SL positioning accuracy). A transmission configuration may be applied to and/or associated with an antenna reference point (ARP) and include one or more the following: WTRU TX timing error information; WTRU TX phase error information; antenna panel placement and orientation; antenna array configuration; and/or a transmission direction.

A WTRU may calibrate the timing error and/or phase error information (e.g., due to internal clock drift, group delay) specific to a transmission of an ARP. A signal transmitted at an ARP may experience a time delay and/or phase shift (e.g., caused by baseband and RF signal processing before the transmission at an ARP). The WTRU may calibrate this internal timing delay and/or phase shift specific to TX hardware components (e.g., a transmitter and connected antenna array/panel) used for each ARP. The WTRU may compensate the timing error and/or phase error (e.g., according to the calibration). Due to WTRU capability, there may be remaining timing error and/or phase error (e.g., that the WTRU may not be able to compensate). The WTRU may associate the error information with an ARP and an SL-PRS transmission performed at the ARP. A WTRU may use the error information in an SL positioning calculation (e.g., based SL position measurement performed on the SL-PRS transmission at the ARP).

A WTRU may be equipped with one or more (e.g., multiple) antenna panel(s) and/or antenna array(s). A vehicle WTRU may have an antenna array/panel in the front bumper, rear bumper, and/or on top of the rooftop. A roadside unit (RSU) may have an antenna array/panel installed at a fixed orientation (e.g., to provide a pre-determined spatial coverage). The antenna/panel used for an APR may be included in a transmission configuration. The WTRU may apply the antenna/panel information for SL positioning calculation (e.g., based on SL-PRS transmission performed at the ARP).

An antenna array may include a number of antenna elements of the array. A TX beam may be generated by an antenna panel (e.g., with a beamwidth that may depend on the operating frequency, number of antenna element, beamforming method, etc.). In a first frequency (FR1), the beamwidth may wide (e.g., as wide as 120 degrees). The center of the beamwidth (e.g., with maximum gain) may indicate a transmission direction. The center of the beamwidth may be indicated (e.g., using an antenna transmission boresight). Spatial characteristics of an SL-PRS transmission performed at an ARP may be indicated by the transmission configuration information regarding antenna array/panel placement and orientation, antenna array configuration, and/or transmission direction. A WTRU may use the transmission configuration information in an SL positioning calculation. The SL positioning calculation may be based on an SL position measurement (e.g., angle-based) performed on the SL-PRS transmission at the ARP.

Feature(s) associated with an anchor WTRU performing multiple sets of SL-PRS transmissions for PRU-based SL positioning are provided herein.

A WTRU (e.g., an anchor WTRU) may determine to perform a number of SL-PRS transmission sets for PRU-based and target WTRU-based SL positioning measurements. In one example, a WTRU may determine the number of SL-PRS transmission sets based on the supported transmission configurations (e.g., the number of supported antenna panels with different orientation). In a set of SL-PRS transmission (e.g., each set of SL-PRS transmissions), a WTRU may determine to perform SL-PRS transmission using ARPs with different timing error information, phase error information, antenna array configuration, and/or transmission direction. A WTRU may transmit SL-PRS transmissions from one antenna panel using different transmitters. An SL-PRS transmission (e.g., each SL-PRS transmission) may be associated with different timing and/or phase error information. The SL-PRS transmissions (e.g., each performed SL-PRS transmission) may be associated with different a transmission configuration (e.g., in terms of antenna panel, antenna array, timing/phase error information, and/or transmission direction).

A WTRU (e.g., an anchor WTRU) may perform resource selection for determined SL-PRS transmissions. The WTRU may determine a measurement gap for each SL-PRS transmission set and select resources for the SL-PRS set within the measurement gap. For example, the first positioning measurement may associated with a first set of positioning reference signals (PRSs), where PRSs in the first set of PRSs are associated with a first measurement gap. The second positioning measurement may be associated with a second set of PRSs, where PRSs in the second set of PRSs are associated with a second measurement gap. The measurement gap may include a number of slots (e.g., one or more slots). During the measurement gap slots a WTRU may perform SL-PRS measurement(s) and/or related processing. During the measurement gap slots, the WTRU may suspend other SL transmission and/or reception activities.

An anchor WTRU may send (e.g., to the target WTRU and the PRU) a positioning measurement request that indicates: a first request for the PRU to perform the first positioning measurement on a first set of positioning reference signals (PRSs) and the second positioning measurement on a second set of PRSs, and a second request for the target WTRU to perform the third positioning measurement on the first set of PRSs and the fourth positioning measurement on the second set of PRSs. the anchor WTRU may indicate the selected resources and/or measurement gap information (e.g., in the SL positioning request transmission). The WTRU may provide SL-PRS configuration (e.g., comb pattern) and/or an SL positioning method (e.g., an angle and/or timing measurement) in the request transmission. An anchor WTRU may perform a groupcast transmission (e.g., to send the request and configuration information to a target WTRU and associated PRU). The anchor WTRU may indicate an SL-PRS transmission ID associated with the corresponding resource selected for the SL-PRS transmission.

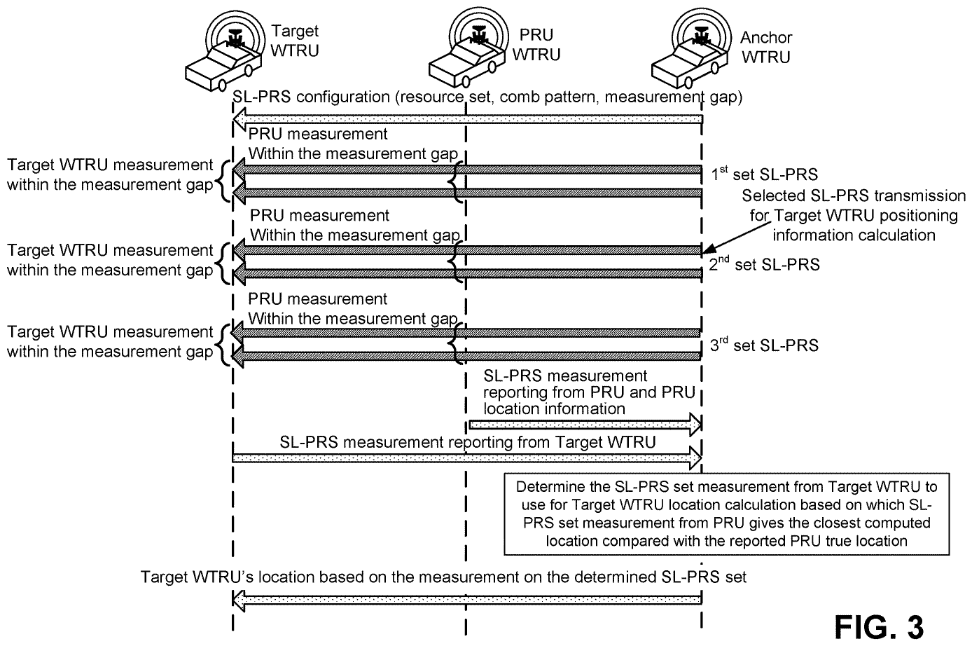

A WTRU may transmit the determined sets of SL-PRS transmissions (e.g., in the selected resources). FIG. 3 illustrates an example of an anchor WTRU determining a set of SL-PRS transmissions for target WTRU-based SL positioning calculation (e.g., based on PRU-based SL positioning measurement results of each set of SL-PRS transmissions).

As illustrated in FIG. 3, a target WTRU and associated PRU may perform the indicated SL positioning measurement on the SL-PRS transmissions during the indicated measurement gap within the configured resources. The anchor WTRU may receive an indication of the position of the PRU (e.g., the PRU may include its known location in the measurement reporting). An anchor WTRU may receive a measurement report including the measurement result for each SL-PRS transmission (e.g., from both the target WTRU and PRU). For example, the anchor WTRU may receive a first positioning measurement and a second positioning measurement from the PRU, and a third positioning measurement and a fourth positioning measurement from a target WTRU. An SL-PRS transmission ID may be included in the measurement report. The SL-PRS transmission ID may identify the corresponding SL-PRS measurement results. For a given SL-PRS transmission (e.g., for each performed SL-PRS transmission) with a specific transmission configuration, an anchor WTRU may receive PRU-based measurement results and target WTRU-based measurement results.

An anchor WTRU may determine a target WTRU-based SL positioning measurement result (e.g., for a target WTRU position calculation).

A WTRU (e.g., an anchor WTRU) may select/determine a received target-WTRU SL-PRS measurement result. For example, the anchor WTRU may select a positioning measurement, from at least the third positioning measurement and the fourth positioning measurement, based on the first positioning measurement, the second positioning measurement, and the position of the PRU.

The anchor WTRU may calculate a position of the target WTRU based on the selected positioning measurement. For example, the anchor WTRU may use the received target-WTRU SL-PRS measurement result to perform a target WTRU position calculation (e.g., based on the received PRU-based SL-PRS measurements).

The anchor WTRU may select/determine the positioning measurement based on error factors associated with the positioning measurements. For example, the anchor WTRU may determine an SL position measurement error factor for a PRU-based SL-PRS measurement (e.g., each received PRU-based SL-PRS measurement) based on one or more measurements. For example, the WTRU may determine an SL position measurement error factor based on an expected PRU-based SL positioning measurement result (e.g., angular and round trip time result based on the known location of both the PRU and the anchor WTRU). The WTRU may determine an SL position measurement error factor based on the reported PRU-based SL positioning measurement result based on SL-PRS transmission.

A WTRU may determine a best PRU-based SL-PRS measurement (e.g., the SL-PRS measurement with the smallest error factor) and the corresponding SL-PRS transmission identity. The error factor may be a timing error between a positioning measurement and the position of the PRU, or a phase error between the positioning measurement and the position of the PRU. For example, the timing offset and/or angular offset calculated based on the PRU-based SL-PRS measurement may be the smallest amongst received PRU-based SL-PRS measurement results. For example, the anchor WTRU may determine a first error factor between the first positioning measurement and the position of the PRU, and a second error factor between the second positioning measurement and the position of the PRU. On a condition that the first error factor is smaller than the second error factor, the anchor WTRU may select the third positioning measurement. On a condition that the second error factor is smaller than the first error factor, the anchor WTRU may select the fourth positioning measurement

In some examples, the anchor WTRU may receive more than two positioning measurements from the target WTRU. In this case, the anchor WTRU may select a positioning measurement based on the three of more positioning measurements received from the target WTRU.

The channel conditions may be highly correlated between the anchor WTRU-PRU SL and the anchor WTRU-target WTRU SL (e.g., based on a PRU selection procedure). The target WTRU-based SL positioning measurement and the PRU-based SL positioning measurement on the same SL-PRS transmission may be QCLed (e.g., and experience very similar channel impairments). The SL-PRS transmission with the best PRU-based SL-PRS measurement result may be associated with (e.g., may provide) the best target WTRU-based SL-PRS measurement (e.g., the best target WTRU-based SL-PRS measurement may be the target WTRU-based SL-PRS measurement with the smallest error factor among received target WTRU-based measurement results for performed SL-PRS transmissions).

A WTRU may determine to use the received results of a target WTRU-based measurement (e.g., performed on the SL-PRS transmission of the determined SL-PRS transmission identity) for a target WTRU location information calculation. In the example illustrated in FIG. 3, a WTRU may determine to use a target WTRU-based measurement result on a first SL-PRS transmission in the second set of SL-PRS transmissions. The target WTRU-based measurement result may have the lowest calculated error factor derived from the PRU-based measurement result on the same SL-PRS transmission. A WTRU may calculate the target WTRU location based on the received SL target WTRU-based measurement of the determined SL-PRS transmission. The WTRU may send the location information to the target WTRU.

A WTRU may associate the transmission configuration applied to the determined SL-PRS transmission with the target WTRU and associated PRU for the subsequent SL positioning measurement. For example, a WTRU may apply the same antenna panel/array, transmitter with the same timing and/or phase error information, and/or transmission direction for SL-PRS transmission to the target WTRU and associated PRU.

A WTRU (e.g., an anchor WTRU) may select one or more (e.g., multiple) sets of SL-PRS resources. A set of resources may include resources for an SL-PRS transmission from each anchor WTRU. Resources within one set may be within a measurement gap of one slot or consecutive slots.

The WTRU may send an SL positioning configuration (e.g., in a groupcast transmission). The SL positioning configuration may include: the selected SL-PRS resource sets; a request to a PRU and/or target WTRU for an SL positioning measurement; and/or measurement gap information.

The WTRU may transmit SL-PRS in the selected resource sets. An SL-PRS transmission (e.g., each SL-PRS transmission) may use a different transmission configuration (e.g., including antenna panel, TX beamwidth, timing error, phase error, and/or the like).

The WTRU may receive SL positioning measurements reporting from the PRU and the target WTRU. For example, the anchor WTRU may receive a first positioning measurement and a second positioning measurement from the PRU, and a third positioning measurement and a fourth positioning measurement from the target WTRU. The WTRU may receive an SL-PRS transmission (e.g., each SL-PRS transmission) measured by the PRU and the target WTRU.

The WTRU may determine an error factor (e.g., timing or angle/phase offset for each set of SL-PRS transmissions). The WTRU may determine the error factor based on a PRU-based SL positioning measurement reported by the PRU; and/or the known location of the PRU and the anchor WTRU.

The WTRU may calculate the target WTRU's position (e.g., using an SL positioning measurement reported by the target WTRU using the SL-PRS transmission with the smallest determined error factor).

The WTRU may send the calculated position information to the target WTRU.

An anchor WTRU may send, to a target WTRU and a positioning reference unit (PRU), a positioning measurement request. The positioning measurement request may indicate a first request for the PRU to perform a first positioning measurement on a first set of positioning reference signals (PRSs) and a second positioning measurement on a second set of PRSs, and a second request for the target WTRU to perform a third positioning measurement on the first set of PRSs and a fourth positioning measurement on the second set of PRSs. The anchor WTRU may receive the first positioning measurement and the second positioning measurement from the PRU and the third positioning measurement and the fourth positioning measurement from the target WTRU. The anchor WTRU may obtain a position of the PRU. The anchor WTRU may select a positioning measurement, from the third positioning measurement and the fourth positioning measurement, based on the first positioning measurement, the second positioning measurement, and the position of the PRU. The anchor WTRU may calculate a position of the target WTRU based on the selected positioning measurement. The anchor WTRU may send the calculated position to the target WTRU.

The anchor WTRU may determine a first error factor between the first positioning measurement and the position of the PRU. The anchor WTRU may determine a second error factor between the second positioning measurement and the position of the PRU. On a condition that the first error factor is smaller than the second error factor, the anchor WTRU may select the third positioning measurement. On a condition that the second error factor is smaller than the first error factor, the anchor WTRU may select the fourth positioning measurement.

PRSs in the first set of PRSs may be associated with a first measurement gap. PRSs in the second set of PRSs may be associated with a second measurement gap. The first measurement gap or the second measurement gap may be one slot (e.g., in length).

An anchor WTRU may determine a target WTRU SL-PRS transmission configuration for SL positioning (e.g., based on SL positioning measurements of PRU SL-PRS transmissions).

Feature(s) associated with reception configuration for an SL-PRS transmission are provided herein.

A WTRU may perform an SL-PRS measurement for SL positioning using a reception configuration (e.g., that may impact SL positioning accuracy). A reception configuration may be applied to and/or associated with an antenna reference point (ARP) and include one or more the following: WTRU RX timing error information; WTRU RX phase error information; an antenna panel placement and orientation; an antenna array configuration; and/or a reception direction.

A WTRU may calibrate the timing error and/or phase error information (e.g., due to internal clock drift, group delay) specific to a reception of an ARP. Due to the different hardware parts used between transmission and reception, a WTRU may calibrate the internal timing delay and/or phase shift specific to RX hardware components (e.g., receiver and connected antenna array/panel) used for each ARP. The WTRU may compensate the timing error and/or phase error for reception. The WTRU may associate the remaining timing and/or phase error information (e.g., after compensation) with an ARP and an SL-PRS reception performed at the ARP. A WTRU may use the remaining timing and/or phase error information in an SL positioning calculation (e.g., based on an SL position measurement performed on the SL-PRS reception at the ARP).

For example, the anchor WTRU may determine a first error factor (e.g., timing or phase error) between the first positioning measurement and the position of the PRU. The anchor WTRU may determine a second error factor between the second positioning measurement and the position of the PRU. On a condition that the first error factor is smaller than the second error factor, the anchor WTRU may select the first positioning measurement. On a condition that the second error factor is smaller than the first error factor, the anchor WTRU may select the second positioning measurement. In some examples, the anchor WTRU may receive more than two PRS transmissions from the PRU. In this case, the anchor WTRU may select a positioning measurement based on the positioning measurements associated with the three of more PRS transmissions from the PRU.

A WTRU may be equipped with one or more (e.g., multiple) antenna panel(s) and/or antenna array(s). A vehicle WTRU may have an antenna array/panel in the front bumper, rear bumper, and/or on top of the rooftop. A roadside unit (RSU) may have an antenna array/panel installed at a fixed orientation (e.g., to provide a pre-determined spatial coverage). The antenna/panel used for an APR may be included in a reception configuration. The WTRU may apply the antenna/panel information for an SL positioning calculation (e.g., based on SL-PRS reception performed at the ARP).

An antenna array may include a number of antenna elements of the array. A RX beam may be generated by an antenna panel (e.g., with a beamwidth that may depend on the operating frequency, number of antenna element, beamforming method, etc.). The center of the beamwidth (e.g., with maximum gain) may indicate a reception direction. The center of the beamwidth may be indicated (e.g., using an antenna reception boresight). The spatial characteristics of an SL-PRS reception performed at an ARP may be indicated by the reception configuration information (e.g., regarding antenna array/panel placement and orientation, antenna array configuration, and/or reception direction). A WTRU may use this information in an SL positioning calculation. The SL positioning calculation may be based on an SL positioning measurement (e.g., angle-based) performed on the SL-PRS received at the ARP.

An anchor WTRU may request SL-PRS transmissions. The anchor WTRU may send a PRS request (e.g., to the PRU) that indicates a first request for the PRU to perform the first PRS transmission, a first set of resources associated with the first PRS transmission, a second request for the PRU to perform the second PRS transmission, and a second set of resources associated with the second PRS transmission. The anchor WTRU may perform PRU-based SL-positioning measurements (e.g., based on SL-PRS transmissions using different PRU transmission configurations and anchor WTRU reception configurations).

A WTRU (e.g., a target WTRU and/or PRU) may indicate supported transmission configurations to a peer WTRU in an SL positioning group (e.g., an anchor WTRU). A transmission configuration (e.g., each supported transmission configuration) may be denoted with an index. A transmission configuration (e.g., each supported transmission configuration) may include one or more of the following parameters: WTRU TX timing error information; WTRU TX phase error information; antenna panel placement and orientation; an antenna array configuration; and/or a transmission direction.

An anchor WTRU may perform resource selection for a number of resources (e.g., in accordance with the number of supported transmission configurations indicated by a target WTRU and/or PRU). The anchor WTRU may be (pre)configured with a measurement gap. The anchor WTRU may select resources for SL-PRS transmission(s) within the measurement gap.

An anchor WTRU may send an SL-PRS transmission request to a PRU (e.g., including the selected resources). A resource (e.g., each resource) may be indicated with a transmission configuration index. A PRU may perform SL-PRS transmission in an indicated resource (e.g., using the transmission configuration corresponding to the indicated transmission configuration index). The anchor WTRU may receive a first positioning reference signal (PRS) transmission, a second PRS transmission from the PRU, and an indication of the position of the PRU. The PRU may indicate (e.g., explicitly indicate) the transmission configuration used for SL-PRS transmission in an SCI associated with the SL-PRS.

A WTRU (e.g., an anchor WTRU) may perform SL positioning measurement (e.g., an AoA-based positioning measurement) of each requested SL-PRS transmission in the selected resources. For example, the anchor WTRU may perform a first positioning measurement on the first PRS transmission and a second positioning measurement on the second PRS transmission.

The anchor WTRU may determine a number of reception configurations to use for the SL positioning measurement on the requested SL-PRS transmissions from a PRU. The anchor WTRU may request that a PRU perform a number of SL-PRS transmissions with a measurement gap. The number of SL-PRS transmissions may be the result of the number of requested transmission configurations (e.g., Ntx) multiplied by the number of determined RX transmission configurations (Nrx). For a reception configuration (e.g., each reception configuration), an anchor WTRU may measure a set of SL-PRS transmissions (e.g., using all transmission configurations indicated by a PRU). The anchor WTRU may perform (Nrx) x (Ntx) SL positioning measurements on SL-PRS transmissions from a PRU.

An anchor WTRU may determine a PRU transmission configuration and an anchor WTRU reception configuration (e.g., based on the best PRU-based SL positioning measurement).

The anchor WTRU may select a positioning measurement (e.g., from at least a first positioning measurement and a second positioning measurement, based on the first positioning measurement, the second positioning measurement, and the position of the PRU). For example, the anchor WTRU may determine a best PRU-based SL-PRS measurement (e.g., the SL-PRS measurement with the smallest error factor). The WTRU may determine the best PRU-based SL-PRS based on an expected PRU-based SL positioning measurement result (e.g., an AoA result calculated based on the known location of both PRU and anchor WTRU) and/or the reported PRU-based SL positioning measurement result based on SL-PRS transmission.

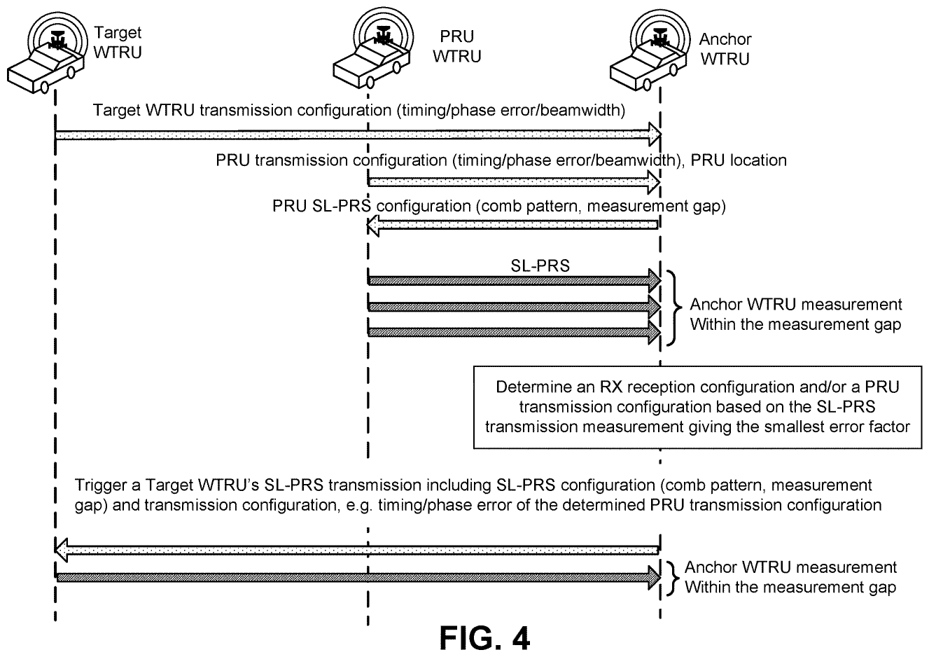

FIG. 4 illustrates an example anchor WTRU determination of a target WTRU's SL-PRS transmission configuration (e.g., based on a PRU-based SL positioning measurement).

An anchor WTRU may determine the index of the transmission configuration by the PRU. The anchor WTRU may determine the index of the reception configuration used for the best PRU-based SL-PRS measurement. The anchor WTRU may determine a transmission configuration reported by a target WTRU corresponding to the determined best transmission configuration by a PRU. The anchor WTRU may select a target WTRU's transmission configuration based on the transmission configuration with the smallest delta in timing error information and/or phase error information compared with the corresponding parameters of the PRU's transmission configuration. The anchor WTRU may select a target WTRU's transmission configuration based on the transmission configuration with the smallest delta in beamwidth compared with the corresponding parameters of the PRU's transmission configuration.

The anchor WTRU may attempt to match the transmission configuration of a target WTRU (e.g., for a subsequent target WTRU-based SL positioning measurement) to the determined transmission configuration of a PRU. For example, the anchor WTRU determine a first transmission configuration associated with the PRU based on the selected positioning measurement. The anchor WTRU may determine a second transmission configuration associated with a target WTRU based on the first transmission configuration associated with the PRU. The anchor WTRU may send, to the target WTRU, an indication of the second transmission configuration. For example, the anchor WTRU may indicate the index of the determined target WTRU's transmission configuration (e.g., in an SL positioning request transmission to the target WTRU). The anchor WTRU may indicate a resource selected for the SL-PRS transmission (e.g., within a measurement gap for the target WTRU-based SL positioning measurement).

An anchor WTRU may provide (e.g., explicitly provide) the determined PRU's transmission configuration parameters in the request transmission. A target WTRU may determine a transmission configuration for the request SL-PRS transmission based on the indicated parameter (e.g., using a TX with a timing error and/or phase error having the smallest delta compared with the indicated timing and/or phase errors).

A WTRU may associate the determined target WTRU's transmission configuration and the corresponding reception configuration with the target WTRU for subsequent SL positioning measurements. For example, an anchor WTRU may apply the same determined receiving antenna panel/array/RX beam for a subsequent SL positioning measurement on an SL-PRS transmission performed by the target WTRU. The anchor WTRU may indicate the index of the determined transmission configuration (e.g., in the request to the target WTRU).

A WTRU (e.g., an anchor WTRU) may receive SL-PRS transmission configuration information from a PRU and a target WTRU. The SL-PRS transmission configuration information may include a timing error, phase error, beamwidth, etc. and/or a PRU location from the PRU.

The WTRU may select one or more (e.g., multiple) resources for the PRU's SL-PRS transmission. For example, resources within a set may be within a measurement gap of one slot or consecutive slots.

The WTRU may send a request/trigger to the PRU for SL-PRS transmissions. The request/trigger may include an SL-PRS configuration (e.g., resources, comb pattern, etc.); and/or a transmission configuration index (e.g., indicated for each resource).

The WTRU may perform PRU-based SL positioning measurement (e.g., AoA) on an SL-PRS transmission (e.g., each SL-PRS transmission) from the PRU. The PRU-based SL positioning measurements (e.g., each PRU-based SL positioning measurement) may be performed using a different reception configuration (e.g., receiving antenna panel, receiving antenna array, RX beam, etc.).

The WTRU may determine an error factor (e.g., a timing or angle offset) for each performed PRU-based SL positioning measurement result. The WTRU may determine the error factor based on a PRU-based SL positioning measurement (e.g., reported by the PRU); and/or the known location of the PRU and the anchor WTRU.

The WTRU may determine a PRU-based SL positioning measurement result (e.g., that has the smallest error factor). The WTRU may determine a corresponding reception configuration. The WTRU may determine the PRU's transmission configuration.

The WTRU may determine a transmission configuration for a target WTRU (e.g., based on the determined PRU's transmission configuration). For example, a transmission configuration with the smallest delta timing error, phase error and/or beamwidth compared with the determined PRU's transmission configuration may be selected.

The WTRU may indicate the determined transmission configuration to the target WTRU.

An anchor WTRU may send a positioning reference signal (PRS) request to a positioning reference unit (PRU). The PRS request may indicate a first request for the PRU to perform a first PRS transmission, and a second request for the PRU to perform a second PRS transmission. The anchor WTRU may receive the first PRS transmission and the second PRS transmission. The anchor WTRU may perform a first positioning measurement on the first PRS transmission and a second positioning measurement on the second PRS transmission. The anchor WTRU may obtain a position of the PRU. The anchor WTRU may select a positioning measurement, from the first positioning measurement and the second positioning measurement, based on the first positioning measurement, the second positioning measurement, and the position of the PRU. The anchor WTRU may determine, based on the selected positioning measurement, a first transmission configuration associated with the PRU. The anchor WTRU may determine a second transmission configuration associated with a target WTRU based on the first transmission configuration associated with the PRU. The anchor WTRU may send an indication to the target WTRU. The indication may indicate the second transmission configuration.

The anchor WTRU may determine a first error factor between the first positioning measurement and the position of the PRU. The anchor WTRU may determine a second error factor between the second positioning measurement and the position of the PRU. On a condition that the first error factor is smaller than the second error factor, the anchor WTRU may select the first positioning measurement. On a condition that the second error factor is smaller than the first error factor, the anchor WTRU may select the second positioning measurement. The anchor WTRU may receive a first indication of a current transmission configuration for the PRU and a second indication of a current transmission configuration for the target WTRU. The anchor WTRU may determine, based on the selected positioning measurement, a reception configuration associated with the anchor WTRU.

An anchor WTRU may determine whether or not to include a PRU measurement for RTT-based SL positioning (e.g., based on channel condition measurements of target WTRU-to-anchor WTRU SL and a PRU-to-anchor WTRU SL).

Feature(s) associated with RTT-based SL positioning with PRU assistance are provided herein.

A WTRU (e.g., a target WTRU or an anchor WTRU) may transmit an SL synchronization signal. The WTRU may send an RTT (Round Trip Time)-based SL positioning configuration to peer WTRUs in an SL positioning group (e.g., a target WTRU, an anchor WTRU and associated PRU). The RTT-based SL positioning configuration may include one or more of the following: a synchronization request; a RTT-based SL positioning request; a resource allocation for SL-PRS transmissions; an SL-PRS transmission request; and/or a synchronization request. For example, the anchor WTRU may send, to the target WTRU and the PRU, a positioning measurement request that indicates a first set of resources for the first PRS transmission and a second set of resources for the second PRS transmission.

A WTRU may become a SyncRef WTRU for an RTT-based SL positioning session. A WTRU may perform transmissions of SL Synchronization Signal Block (SL SSB) (e.g., including SL primary and secondary synchronization signal (SL PSS/SSS) and SL PBCH according to the SL SSB (pre)configuration of an SL carrier).

In a synchronization request, a WTRU (e.g., an anchor WTRU) may request peer WTRUs (e.g., a target WTRU and associated PRU) to synchronize with the transmitted SL SSB. The request may indicate identity information of the WTRU's SL SSB transmission. The SL SSB identity may be an SL SSB ID indicated by the index of SL PSS sequence and/or SL SSS. The SL SSB identity may be an SL SSB ID indicated (e.g., explicitly indicated) in the transmitted SL PBCH. If the peer WTRUs use the indicated SL SSB as a synchronization source, the timing reference misalignment error among the WTRUs in an SL positioning group may be reduced (e.g., to improve the RTT-based SL positioning accuracy).

A WTRU (e.g., an anchor WTRU or a target WTRU) may indicate (e.g., in the request) a synchronization source (e.g., its own synchronization source, for example, a gNB or a SyncRef WTRU) and corresponding identity information. For example, a cell ID of the gNB sync resource and SL SSB ID of the SyncRef WTRU may be indicated in the synchronization request. The peer WTRUs (e.g., a target WTRU, anchor WTRU, and/or PRU) may synchronize with the indicated synchronization source.

Feature(s) associated with resource allocation for SL-PRS transmissions in the RTT-based SL positioning are provided herein.

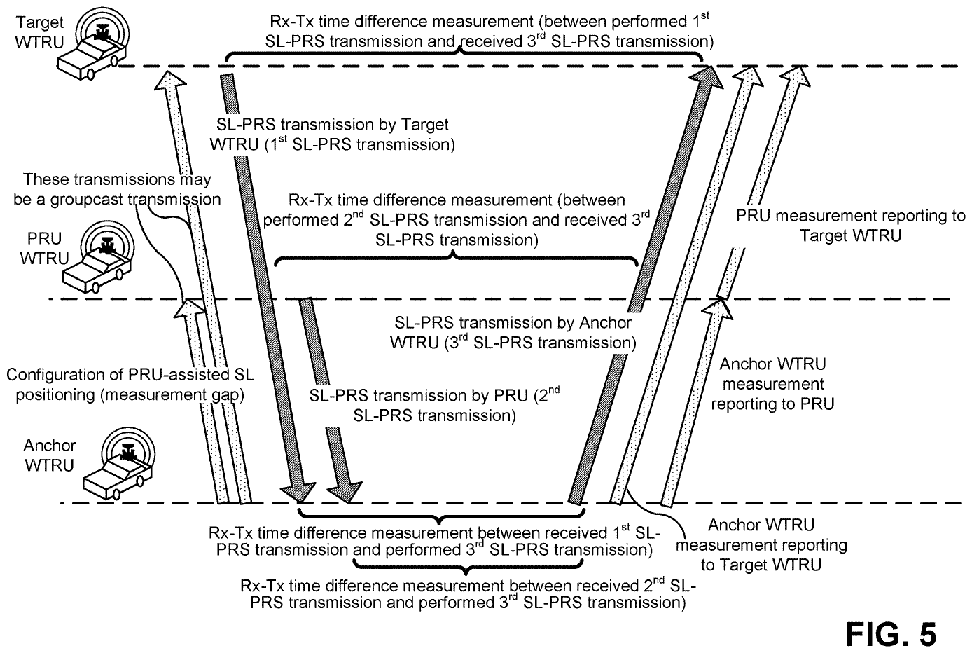

An RTT-based SL positioning with PRU assistance may be based on one or more SL-PRS transmissions (e.g., performed in a sequential order, as illustrated in FIG. 5).

FIG. 5 illustrates example RTT-based SL positioning with PRU assistance information.

As illustrated in FIG. 5, a target WTRU may perform an SL-PRS transmission (e.g., sometime referred to herein as a first SL-PRS transmission of a RTT-bases SL positioning session). The anchor WTRU may receive the first SL-PRS transmission from the target WTRU. A PRU associated with the target WTRU may perform an SL-PRS transmission (e.g., sometimes referred to herein as a second SL-PRS transmission of a RTT-bases SL positioning session). The anchor WTRU may receive the second SL-PRS transmission from the PRU. The anchor WTRU may transmit an SL-PRS transmission (e.g., sometimes referred to herein as a third SL-PRS transmission of a RTT-bases SL positioning session) to the target WTRU and the PRU.

To reduce the WTRU movement and time drift of the WTRU internal clock, a WTRU may be (pre)configured with a measurement gap for RTT-based SL positioning SL-PRS transmissions. The measurement gap duration may be associated with a RTT measurement accuracy (e.g., a required RTT measurement accuracy). A WTRU (e.g., an anchor WTRU) may determine a measurement gap (e.g., based on the RTT measurement accuracy requirement). The WTRU may perform resource selection within the measurement gap.

An anchor WTRU may send an SL positioning measurement request (e.g., with the RTT-based SL positioning configuration) to a target WTRU and its associated PRU. The anchor WTRU may indicate (e.g., in the request transmission) the selected resources for the first and second SL-PRS transmissions.

Feature(s) associated with RTT-based SL positioning with PRU assistance are provided herein.

An anchor WTRU may perform the one or more measurements (e.g., based on the received first and second SL-PRS transmission, and the reserved third SL-PRS transmission). For example, the anchor WTRU may determine a first positioning measurement based on the first PRS transmission and the third PRS transmission, and a second positioning measurement based on the second PRS transmission and the third PRS transmission. The anchor WTRU may perform a first channel condition measurement associated with (e.g., on) the first SL-PRS transmission. The anchor WTRU may perform a second channel condition measurement associated with (e.g., on) the second SL-PRS transmission.

The anchor WTRU may determine a first time difference between reception of the first PRS transmission and transmission of the third PRS transmission (e.g., an RX-TX time difference measurement between the received first and the reserved SL-PRS transmission third SL-PRS transmission). The anchor WTRU may determine a second time difference between reception of the second PRS transmission and transmission of the third PRS transmission (e.g., an RX-TX time difference measurement between the received second SL-PRS transmission and the reserved third SL-PRS transmission.

An anchor WTRU may perform a channel condition measurement (e.g., as discussed herein). An anchor WTRU may perform a RX-TX time difference measurement (e.g., based on the time different between a received SL-PRS transmission(s) and a reserved/transmitted SL-PRS transmission). The time difference may be measured as the time difference between the slot (e.g., including the received SL-PRS and the slot including the transmitted SL-PRS). The time difference may be measured as the time difference between the start or end symbol of the received SL-PRS and start or end symbol of the transmitted SL-PRS. The time difference may be measured as the time difference between the symbol including PSCCH associated with the received SL-PRS and the symbol including PSCCH associated with the transmitted SL-PRS.

The anchor WTRU may determine whether to include the second positioning measurement in a positioning measurement report based on a relative difference between the first channel condition measurement and the second channel condition measurement. For example, the anchor WTRU may determine whether or not the (e.g., two) performed RX-TX time difference measurements are QCLed (e.g., based on the channel condition measurements on the first SL-PRS transmission and the second SL-PRS transmission. For example, the anchor WTRU may determine the RX-TX time difference measurement is QCLed if the relative difference of one or more channel condition metric values measured on the first SL-PRS transmission and the second SL-PRS transmissions are within a (pre)configured threshold. The channel condition metric(s) may be one or more of the following: a RSRP, RSRPP of the first path, a LOS/NLOS indication value, an SINR, a CQI, a delay spread, and/or the like. An anchor WTRU may perform channel condition measurements and SL positioning measurements on the same SL-PRS signals. The determined channel condition correlation status may readily apply to the SL positioning measurements.

The anchor WTRU may determine whether a quasi-colocation relationship exists between the first channel condition measurement and the second channel condition measurement. On a condition that the quasi-colocation relationship does exist between the first channel condition measurement and the second channel condition measurement, the anchor WTRU may include the second positioning measurement in the positioning measurement report. For example, if an anchor WTRU determines the performed RX-TX time difference measurement is QCLed, the anchor WTRU may determine to perform a PRU-assisted RTT SL positioning. The anchor WTRU may include target WTRU-based RX-TX time difference measurements and PRU-based RX-TX time difference measurements in a measurement reporting to a target WTRU. The anchor WTRU may indicate for a PRU to transmit a measurement reporting (e.g., including the RX-TX time difference measurement performed by PRU between the second SL-PRS transmission and third SL-PRS reception).

The anchor WTRU may include its known location information in the measurement reporting. The PRU may include its known location information in the measurement reporting. If a target WTRU receives an indication from the anchor WTRU, the target WTRU may perform PRU-assisted RTT SL positioning (e.g., based on one or more measurement results. For example, the target WTRU may perform target WTRU-based RTT measurements. For example, the target WTRU may determine a RX-TX difference measurement between the reception of first SL-PRS transmission (e.g., from target WTRU) and transmission of third SL-PRS transmission (e.g., performed by the anchor WTRU). The target WTRU may determine a RX-TX difference measurement between transmission of the first SL-PRS transmission and reception of the third SL-PRS transmission (e.g., performed by the target WTRU).

The target WTRU may perform PRU-based RTT measurements. For example, the target WTRU may determine a RX-TX difference measurement between the reception of the second SL-PRS transmission (e.g., from the PRU) and transmission of the third SL-PRS transmission (e.g., performed by the anchor WTRU). The target WTRU may determine a RX-TX difference measurement between transmission of the first SL-PRS transmission and reception of the third SL-PRS transmission (e.g., performed by the PRU).

A target WTRU may determine a RTT estimate based on the PRU-based RTT measurements. The target WTRU may determine an error factor (e.g., a timing offset) between the estimated RTT and the expected RTT between the reported known location of PRU and the anchor WTRU. A target WTRU may determine a RTT estimate based on the target WTRU-based RTT measurements. The target WTRU may use the determined error factor to adjust the RTT estimate between the target WTRU and the anchor WTRU.

If an anchor WTRU determines the performed RX-TX time difference measurements are not QCLed, the anchor WTRU may include RX-TX time difference measurements based on the first SL-PRS transmission and the third SL-PRS transmission (e.g., the target WTRU-based SL positioning measurement in a measurement reporting to a target WTRU). An anchor WTRU may indicate for a PRU to not transmit a measurement reporting to the target WTRU. If the target WTRU receives the indication from the anchor WTRU, the target WTRU may perform an RTT SL positioning based on target WTRU-based RTT measurements. The target WTRU-based RTT measurements may include a RX-TX difference measurement between the reception of the first SL-PRS transmission (e.g., from the target WTRU) and transmission of the third SL-PRS transmission (e.g., performed by the anchor WTRU). The target WTRU-based RTT measurements may include a RX-TX difference measurement between transmission of the first SL-PRS transmission and reception of third SL-PRS transmission (e.g., performed by the target WTRU).

A target WTRU may determine a RTT between the target WTRU and an anchor WTRU. For example, the target WTRU may determine a RTT between the target WTRU and an anchor WTRU based on target WTRU-based RX-TX difference measurements (e.g., reported by an anchor WTRU and performed by the target WTRU, for example, without PRU assistance).

A WTRU (e.g., an anchor WTRU) may perform resource selection for a first SL-PRS by a target WTRU, a second SL-PRS by a PRU, and a third SL-PRS by the anchor WTRU.

The first and second SL-PRS resources may be within the same slot (e.g., same comb pattern with different RE offset).

The time gap between the first, second, and third SL-RPS resources may be within a measurement gap (e.g., based on a measurement accuracy requirement).

The WTRU may send the resource selection and RTT positioning request to the target WTRU and the PRU.

The WTRU may perform channel condition measurements and/or an SL positioning measurement specific to the received first and second SL-PRS transmissions. For example, the WTRU may perform channel condition measurements including RSRP, RSRPP, LOS/NLOS, delay spread, CSI, and/or SINR. The SL positioning measurement may include, for example, a RX-TX time difference relative to the third SL-PRS transmission.

The WTRU may determine to include the SL positioning measurement on the second SL-PRS transmission (PRU) in an SL positioning measurement report (e.g., based on a relative difference between the channel condition measurements on the first and second SL-PRS transmissions). For example, the WTRU may determine to include the SL positioning measurement on the second SL-PRS transmission (PRU) in an SL positioning measurement report based on a condition that the delta RSRP, or delta LOS/NLOS value is lower than a threshold.

The WTRU may send an SL positioning measurement report (e.g., to at least one of the target WTRU or the PRU). For example, the WTRU may include at least the first positioning measurement. For example, the report may include the SL RX-TX time difference report for both the first and second SL-PRS transmissions in the SL positioning measurement report if the condition is met. Otherwise (e.g., if the condition is not met), the WTRU may send an SL positioning measurement report that includes an SL RX-TX time difference report for the first (e.g., only the first) SL-PRS transmission.

An anchor WTRU may receive a first positioning reference signal (PRS) transmission from a target WTRU and a second PRS transmission from a positioning reference unit (PRU). The anchor WTRU may transmit a third PRS transmission to the target WTRU and the PRU. The anchor WTRU may determine a first positioning measurement based on the first PRS transmission and the third PRS transmission, and a second positioning measurement based on the second PRS transmission and the third PRS transmission. The anchor WTRU may perform first channel condition measurements associated with the first PRS transmission, and second channel condition measurements associated with the second PRS transmission. The anchor WTRU may determine whether to include the second positioning measurement in a positioning measurement report based on a relative difference between the first channel condition measurement and the second channel condition measurement. For example, on a condition that the relative difference between the first channel condition measurement and the second channel condition measurement is below a threshold, the anchor WTRU may determine to include the second positioning measurement in the positioning measurement report (e.g., in this case, the position measurement report will indicate the second positioning measurement). On a condition that the relative difference between the first channel condition measurement and the second channel condition measurement is above the threshold, the anchor WTRU may determine to refrain from including the second positioning measurement in the positioning measurement report.

The anchor WTRU may send, to the target WTRU or the PRU, the positioning measurement report. The positioning measurement report may indicate the first positioning measurement.

The anchor WTRU may determine a first time difference between reception of the first PRS transmission and transmission of the third PRS transmission. The anchor WTRU may determine a second time difference between reception of the second PRS transmission and transmission of the third PRS transmission.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that-in the case where there is more than one single medium-there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1. A wireless transmit/receive unit (WTRU) comprising:
a processor configured to:
send a first request to a first candidate positioning reference unit (PRU) and a second candidate PRU, wherein the first request indicates for the first candidate PRU to perform a first channel condition measurement associated with a link between the first candidate PRU and an anchor WTRU, and for the second candidate PRU to perform a second channel condition measurement associated with a link between the second candidate PRU and the anchor WTRU;
receive an indication of the first channel condition measurement from the first candidate PRU, and an indication of the second channel condition measurement from the second candidate PRU;
perform a third channel condition measurement associated with a link between the WTRU and the anchor WTRU;
select a PRU, from at least the first candidate PRU and the second candidate PRU, based on the first channel condition measurement, the second channel condition measurement, and the third channel condition measurement; and
send a second request to the selected PRU, wherein the second request indicates for the selected PRU to join a sidelink positioning group.

2. The WTRU of claim 1, wherein the processor being configured to select the PRU, from at least the first candidate PRU and the second candidate PRU, based on the first channel condition measurement, the second channel condition measurement, and the third channel condition measurement comprises the processor being configured to:
compare the first channel condition measurement with the third channel condition measurement to determine a first channel condition difference;
compare the second channel condition measurement with the third channel condition measurement to determine a second channel condition difference; and
on a condition that the first channel condition difference is smaller than the second channel condition difference, select the first candidate PRU as the PRU.

3. The WTRU of claim 1, wherein the processor being configured to select the PRU, from at least the first candidate PRU and the second candidate PRU, based on the first channel condition measurement, the second channel condition measurement, and the third channel condition measurement comprises the processor being configured to:
compare the first channel condition measurement with the third channel condition measurement to determine a first channel condition difference;
compare the second channel condition measurement with the third channel condition measurement to determine a second channel condition difference; and
on a condition that the second channel condition difference is smaller than the first channel condition difference, select the second candidate PRU as the PRU.

4. The WTRU of any of claims 1 to 3, wherein the anchor WTRU is a first anchor WTRU, and the WTRU is further configured to:
determine that a distance between the first anchor WTRU and a second anchor WTRU is below a threshold;
based on the determination that the distance between the first anchor WTRU and the second anchor WTRU is below the threshold, select sidelink reference signal resources that are multiplexed at a sub-carrier level, wherein the third channel condition measurement is performed based on the selected sidelink reference signal resources; and
perform a fourth channel condition measurement associated with a link between the WTRU and the second anchor WTRU, wherein the fourth channel condition measurement is performed based on the selected sidelink reference signal resources, and wherein the processor being configured to select a PRU is further based on the fourth channel condition measurement.

5. The WTRU of any of claims 1 to 4, wherein the processor is further configured to send the first request to a third candidate PRU, the first request further indicates for the third candidate PRU to perform a fifth channel condition measurement associated with a link between the third candidate PRU and the anchor WTRU, and the processor is further configured to receive an indication of the fifth channel condition measurement from the third candidate PRU, wherein the processor being configured to select the PRU, from at least the first candidate PRU and the second candidate PRU, based on the first channel condition measurement, the second channel condition measurement, and the third channel condition measurement comprises the processor being configured to select the PRU, from the first, second, and third candidate PRUs, based on at least one of: the first channel condition measurement, the second channel condition measurement, the third channel condition measurement, the fourth channel condition measurement, or the fifth channel condition measurement.

6. The WTRU of any of claims 1 to 5, wherein the first request further indicates a time window in which to perform the first channel condition measurement, the second channel condition measurement, and the third channel condition measurement.

7. The WTRU of any of claims 1 to 6, wherein the first request is sent via a broadcast transmission, and wherein the WTRU and the selected PRU have a quasi-colocation relationship.

8. The WTRU of any of claims 1 to 7, wherein the WTRU is a target WTRU, and wherein at least one of the first channel condition measurement, the second channel condition measurement, and the third channel condition measurement comprises one or more of:
a reference signal received power (RSRP) value;
a signal-to-noise ratio;
a line-of-sight indication;
a channel quality indicator;
a delay spread;
a Doppler shift;
a Doppler spread;
an average delay;
a number of detected multi-paths; or
an RSRP per path value.

9. A method, to be performed by a wireless transmit/receive unit (WTRU), the method comprising:
send a first request to a first candidate positioning reference unit (PRU) and a second candidate PRU, wherein the first request indicates for the first candidate PRU to perform a first channel condition measurement associated with a link between the first candidate PRU and an anchor WTRU, and for the second candidate PRU to perform a second channel condition measurement associated with a link between the second candidate PRU and the anchor WTRU;
receive an indication of the first channel condition measurement from the first candidate PRU, and an indication of the second channel condition measurement from the second candidate PRU;
perform a third channel condition measurement associated with a link between the WTRU and the anchor WTRU;
select a PRU, from at least the first candidate PRU and the second candidate PRU, based on the first channel condition measurement, the second channel condition measurement, and the third channel condition measurement; and
send a second request to the selected PRU, wherein the second request indicates for the selected PRU to join a sidelink positioning group.

10. The method of claim 9, wherein selecting the PRU, from at least the first candidate PRU and the second candidate PRU, based on the first channel condition measurement, the second channel condition measurement, and the third channel condition measurement comprises:
comparing the first channel condition measurement with the third channel condition measurement to determine a first channel condition difference;
comparing the second channel condition measurement with the third channel condition measurement to determine a second channel condition difference; and
on a condition that the first channel condition difference is smaller than the second channel condition difference, selecting the first candidate PRU as the PRU.

11. The method of claim 9, wherein selecting the PRU, from at least the first candidate PRU and the second candidate PRU, based on the first channel condition measurement, the second channel condition measurement, and the third channel condition measurement comprises:
comparing the first channel condition measurement with the third channel condition measurement to determine a first channel condition difference;
comparing the second channel condition measurement with the third channel condition measurement to determine a second channel condition difference; and
on a condition that the second channel condition difference is smaller than the first channel condition difference, selecting the second candidate PRU as the PRU.

12. The method of any of claims 9 to 11, wherein the anchor WTRU is a first anchor WTRU, and the method further comprises:
determining that a distance between the first anchor WTRU and a second anchor WTRU is below a threshold;
based on the determination that the distance between the first anchor WTRU and the second anchor WTRU is below the threshold, selecting sidelink reference signal resources that are multiplexed at a sub-carrier level, wherein the third channel condition measurement is performed based on the selected sidelink reference signal resources; and
performing a fourth channel condition measurement associated with a link between the WTRU and the second anchor WTRU, wherein the fourth channel condition measurement is performed based on the selected sidelink reference signal resources, and wherein the processor being configured to select a PRU is further based on the fourth channel condition measurement.

13. The method of any of claims 9 to 12, wherein the method further comprises sending the first request to a third candidate PRU, the first request further indicates for the third candidate PRU to perform a fifth channel condition measurement associated with a link between the third candidate PRU and the anchor WTRU, and the method further comprises receiving an indication of the fifth channel condition measurement from the third candidate PRU, wherein selecting the PRU, from at least the first candidate PRU and the second candidate PRU, based on the first channel condition measurement, the second channel condition measurement, and the third channel condition measurement comprises selecting the PRU, from the first, second, and third candidate PRUs, based on at least one of: the first channel condition measurement, the second channel condition measurement, the third channel condition measurement, the fourth channel condition measurement, or the fifth channel condition measurement.

14. The method of any of claims 9 to 13, wherein the first request further indicates a time window in which to perform the first channel condition measurement, the second channel condition measurement, and the third channel condition measurement.

15. The method of any of claims 9 to 14, wherein the first request is sent via a broadcast transmission, and wherein the WTRU and the selected PRU have a quasi-colocation relationship.

16. The method of any of claims 9 to 15, wherein the WTRU is a target WTRU, and wherein at least one of the first channel condition measurement, the second channel condition measurement, and the third channel condition measurement comprises one or more of:
a reference signal received power (RSRP) value;
a signal-to-noise ratio;
a line-of-sight indication;
a channel quality indicator;
a delay spread;
a Doppler shift;
a Doppler spread;
an average delay;
a number of detected multi-paths; or
an RSRP per path value.
